(19) United States
(12) Patent Application Publication
(10) Pub. No.: US 2019/0130030 A1
(43) Pub. Date: May 2, 2019

(54) GENERATION METHOD, GENERATION DEVICE, AND RECORDING MEDIUM

(71) Applicant: FUJITSU LIMITED, Kawasaki-shi (JP)

(72) Inventor: Yasutaka IGUCHI, Kawasaki (JP)

(73) Assignee: FUJITSU LIMITED, Kawasaki-shi (JP)

(21) Appl. No.: 16/162,336

(22) Filed: Oct. 16, 2018

(30) Foreign Application Priority Data
Oct. 30, 2017 (JP) 2017-209622

(51) Int. Cl. G06F 17/30; G06F 17/27

(52) U.S. Cl. CPC G06F 17/30713; G06F 17/2785; G06F 17/30719

(57) ABSTRACT

A non-transitory computer-readable recording medium stores therein a generation program that causes a computer to execute a process including: calculating similarities respectively, between first data and second data included in each pair of data stored in a storage; extracting, from a plurality of pairs of data stored in the storage, a pair whose calculated similarity meets standards; and generating third data that contains information on the first data contained in the extracted pair, information on the second data contained in the extracted pair, and information on whether the first data and the second data that are contained in the extracted pair are similar to each other.

### CROSS-REFERENCE TO RELATED APPLICATION

This application is based upon and claims the benefit of priority of the prior Japanese Patent Application No. 2017-209622, filed on Oct. 30, 2017, the entire contents of which are incorporated herein by reference.

### FIELD

The embodiments discussed herein are related to a generation method, a generation device, and a computer-readable recording medium.

### BACKGROUND

A technology that enables, in a work of an answerer to answer a question of a questioner, the answerer to efficiently work to lead the questioner to an appropriate answer even with less expert knowledge and less work is known. For example, a technology to extract inquiry cases that can be reused later from messages that are communicated between questioners and answerers, accumulate questions and answers contained in the cases in association with each other, and search for and use a case similar to a new question is known.

Furthermore, a technology to, even when a language in which a database to be searched is written and a language in which an input keyword is written are different from each other, output a search result that agrees with the input keyword is known. For example, a technology to, when an input keyword in Japanese is input, convert the input keyword from Japanese to English to generate a search keyword in English and search a database for texts in English containing the search keyword in English is known. The technology enables English-Japanese translation of the searched texts in English to convert the texts in English into texts in Japanese and comparison of the texts in Japanese with the input keyword in Japanese to evaluate appropriateness of the search result that is searched for from the database.

Furthermore, a technology to clusters similar information is known. For example, a technology to divide each of multiple texts into equal multiple clusters based on results of evaluating similarity of a text with each of all the texts including the text is known. Furthermore, a technology to extract IDs of data of business cards, etc., and part of item data from a record of the business cards in real business card data and collect them under given conditions on acquaintances, etc., to configure multiple sets of simple business card data is known.
Patent Document 1: Japanese Laid-open Patent Publication No. 2006-092473
Patent Document 2: Japanese Laid-open Patent Publication No. 11-219368
Patent Document 3: Japanese Laid-open Patent Publication No. 2003-030224
Patent Document 4: Japanese Laid-open Patent Publication No. 2000-357175

### SUMMARY

According to an aspect of the embodiment, a non-transitory computer-readable recording medium stores therein a generation program that causes a computer to execute a process including: calculating similarities respectively, between first data and second data included in each pair of data stored in a storage; extracting, from a plurality of pairs of data stored in the storage, a pair whose calculated similarity meets standards; and generating third data that contains information on the first data contained in the extracted pair, information on the second data contained in the extracted pair, and information on whether the first data and the second data that are contained in the extracted pair are similar to each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary use of correct data that is generated in a first embodiment;

FIG. 2 is a diagram illustrating an exemplary distribution of similarities each between incidents;

FIG. 3 is a diagram illustrating an exemplary correct data generation process of a background technology;

FIG. 4 is a diagram illustrating an exemplary generation device in the first embodiment;

FIG. 5 is a diagram illustrating an exemplary incident storage in the first embodiment;

FIG. 6 is a diagram illustrating an exemplary correct data storage in the first embodiment;

FIG. 7 is a diagram illustrating an exemplary cluster storage in the first embodiment;

FIG. 8 is a flowchart illustrating an exemplary correct data generation process in the first embodiment;

FIG. 9 is a diagram illustrating exemplary similar incidents;

FIG. 10 is a diagram illustrating a pair extraction process in a second embodiment;

FIG. 11 is a diagram illustrating an exemplary similarity calculation process in the second embodiment;

FIG. 12 is a diagram illustrating an exemplary clustering evaluation process in the second embodiment;

FIG. 13 is a diagram illustrating an exemplary generation device in the second embodiment;

FIG. 14 is a flowchart illustrating a correct data generation process in the second embodiment; and

FIG. 15 is a diagram illustrating an exemplary hardware configuration.

### DESCRIPTION OF EMBODIMENT(S)

For example, in order to specify an optimum similarity calculation method that is used to perform clustering on vast amounts of texts, a determination process may be performed according to each similarity calculation method using correct data representing whether texts are similar to each other. In the above-described technology, however, it is not easy to extract pairs of texts that are dealt with as correct data from vast amounts of texts. For example, it is not efficient to extract texts similar to each other that have to be determined as a correct example.

Preferred embodiments will be explained with reference to accompanying drawings. The embodiments do not limit the invention. The embodiments described below may be combined appropriately as long as no inconsistency is caused.

### [a] First Embodiment

A generation device 10 in a first embodiment to be described below generates correct data that is used to generate a learning model from data between texts contained in a database (DB), such as frequently asked questions (FAQ) at a call center. Texts contained in the database on which clustering is performed can be referred to as “incidents” below. The generation device 10 is an exemplary computer device, such as a server, a personal computer, or a tablet.

Each set of “correct data” in the first embodiment is data containing a combination of two incidents and information indicating whether the incidents are similar to each other. A pair of incidents that are determined as being similar to each other can be denoted as “positive example” and a pair of incidents that are determined as not being similar to each other can be denoted as “negative example” below.

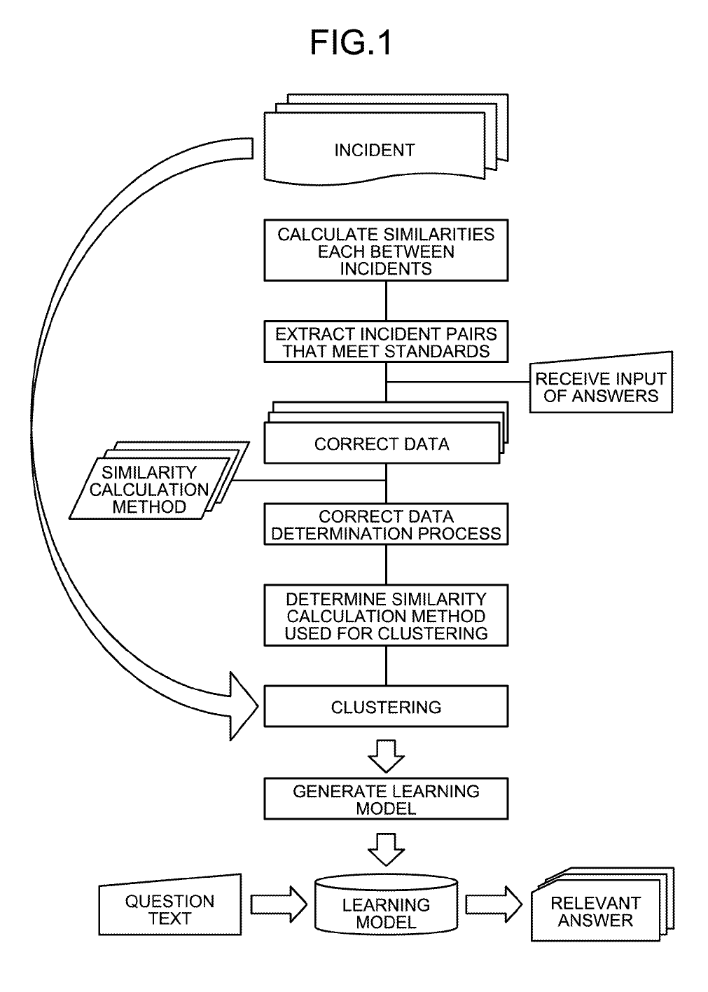

The correct data in the first embodiment is used to determine a similarity calculation method that is used to perform clustering on incidents. FIG. 1 is a diagram illustrating an exemplary use of correct data that is generated in the first embodiment. As illustrated in FIG. 1, in the first embodiment, a learning model is generated from incidents and a question text is input to the learning model and thus relevant answers are extracted.

As illustrated in FIG. 1, generally, when generating a learning model from incidents, clustering is performed on a vast number of incidents and clusters into each of which similar incidents are classified are used as learning data to generate a learning model. A learning model is generated by segmenting a text group, such as incidents, into words by morphological analysis and learning word vectors (bag of words) of distributed representations corresponding to the group of the segmented words. A word distributed representation is a multi-dimensional vector that represents each word in quantified continuous values with respect to multiple dimensions that are respective characteristic elements between words. As word distributed representations can be learned by a known technology, such as Word2Vec, detailed descriptions thereof will be omitted.

When the accuracy of clusters to be used as learning data is low, for example, when incidents in a pair that have to be a positive example are classified into different clusters or, on the contrary, when incidents in a pair that have to be a negative example are classified into the same cluster, the quality of the learning model may lower. When the quality of the learning model lowers, for example, it may be impossible to extract an appropriate answer to a question text. Thus, in the first embodiment, clustering is performed on incidents using a similarity calculation method achieving the highest accuracy among multiple similarity calculation methods.

Accuracy of a similarity calculation method can be determined based on a rate of correction obtained when the similarity calculation method is applied to a pair of incidents contained in correct data, that is, can be determined by classifying the pair into a positive example or a negative example and based on how much the result of the classifying and the correct data match.

As described above, it is not easy to extract pairs of incidents that are dealt with as correct data. For example, when the number of incidents is n, the number of pairs on which determinations are made is (the square of n/2). Furthermore, there may be a large number of pairs of incidents that are obviously negative examples because the incidents are not similar to each other at all and of pairs of incidents that are obviously positive example because the incidents match completely.

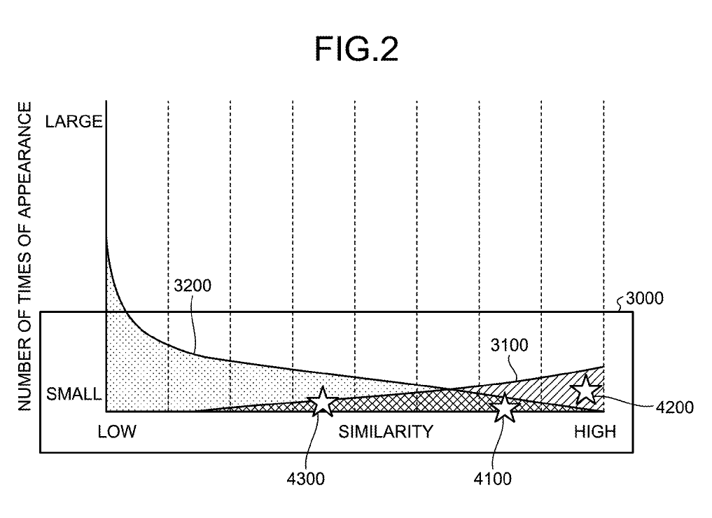

FIG. 2 is a diagram illustrating an exemplary distribution of similarity between incidents. The similarity illustrated in FIG. 2 is not necessarily the same as that of the similarity calculation method described above. The graph represented in FIG. 2 illustrates a distribution of similarity between incidents in pairs. Area 3100 indicates the number of pairs that have to be dealt with as positive examples and Area 3200 indicates the number of pairs that have to be dealt with as negative examples. As illustrated in FIG. 2, the number of pairs that have to be dealt with as negative examples is 0 with respect to pairs of incidents that have the best similarity, that is, that match completely, but the number increases as the similarity decreases. On the other hand, the number of pairs that have to be dealt with as positive examples gradually decreases as the similarity lowers and the number of pairs each of which has a low similarity and has to be dealt with as a positive example reduces distinctly. The graph represented in FIG. 2 illustrates a case where most of the pairs have distinctly low similarities and are dealt with as negative examples.

Pair 4100 represented in FIG. 2 represents an exemplary pair that has a high similarity but that is not a positive example but a negative example. Pair 4200 represents an exemplary pair that has a high similarity and that is a positive example. Pair 4300 represents an exemplary pair that has a low similarity but that is not a negative example but a positive example.

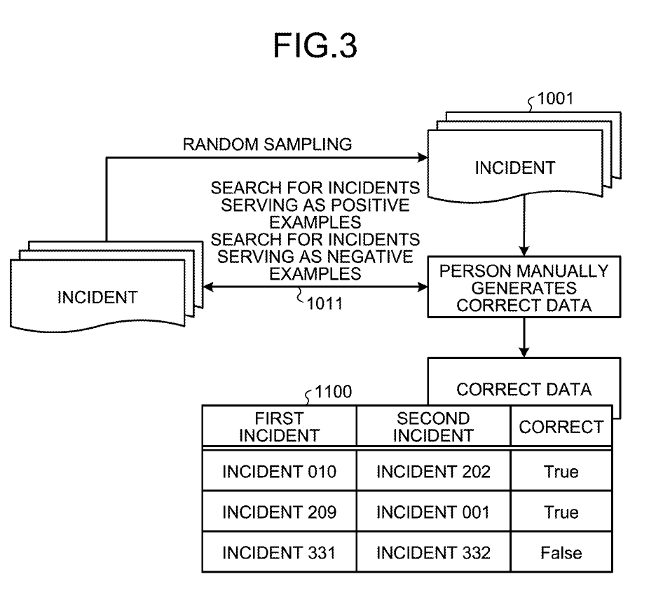

In the background technology, correct data is generated by performing the process illustrated in FIG. 3. FIG. 3 is a diagram illustrating an exemplary correct data generation process in the background technology. For the background technology, for example, a technology enabling a person to manually create correct data 1100 to an incident group 1001 of incidents that are sampled randomly from incidents is known. Another technology enabling a person to manually create the correct data 1100 to a search result that is obtained by searching for incidents that are likely to serve as positive examples and incidents that are likely to serve as negative examples without random sampling is known.

When the ratio of positive examples and negative examples contained in pairs is disproportionate, in random sampling, the possibility that no positive example is contained or the possibility that no negative example is contained increases. Furthermore, when the number of incidents is huge, it is insufficient to specify pairs serving as positive examples and pairs serving as negative examples without performing random sampling.

Thus, in the first embodiment, first of all, the generation program causes a computer to execute a process of calculating similarity between incidents and extracting a pair whose similarity meets standards. The generation program further causes the computer to execute a process of receiving an input of correct information indicating whether the pair corresponds to a positive example or a negative example. Correct information is input, for example, in a way that a user checks a pair of incidents by sight and determine whether the pair is a positive example or a negative example.

As described above, the generation program in the first embodiment enables calculating a similarity per pair of texts, assigning information indicating whether a pair is a positive example to a pair whose similarity meets the standards, and generating correct data and thus enables efficient generation of correct data that is used to determine a method of calculating a similarity between texts.

Functional Block

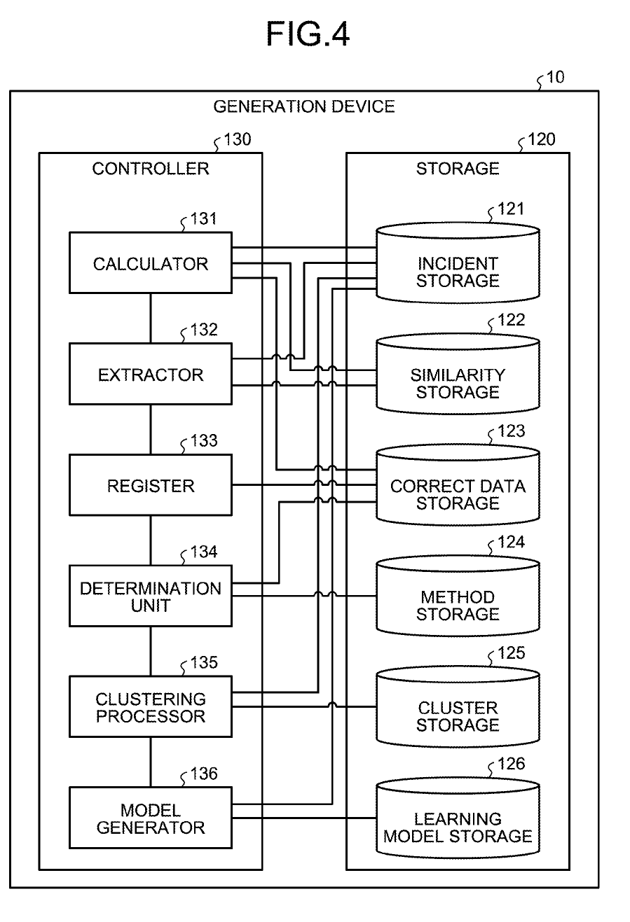

The exemplary generation device 10 in the first embodiment will be described using FIG. 4. FIG. 4 is a diagram illustrating the exemplary generation device in the first embodiment. As illustrated in FIG. 4, the generation device 10 in the first embodiment includes a storage 120 and a controller 130.

The storage 120 is an exemplary storage device that stores programs and data and is, for example, a memory or a processor. The storage 120 stores an incident storage 121, a similarity storage 122, a correct data storage 123, a method storage 124, a cluster storage 125 and a learning model storage 126.

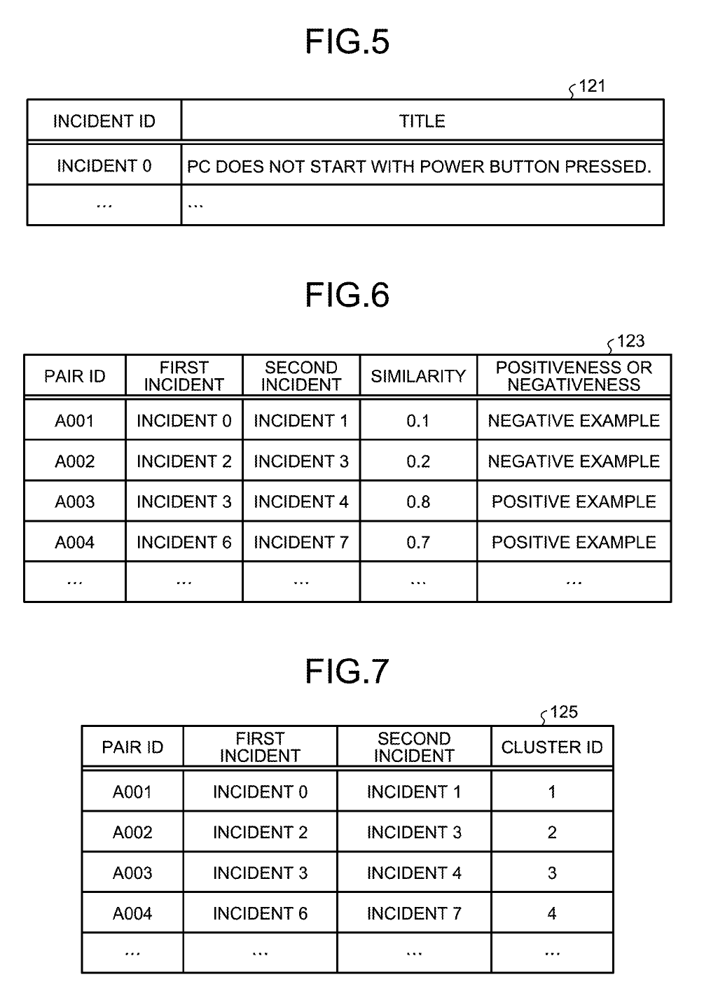

The incident storage 121 stores information on incidents. FIG. 5 is a diagram illustrating an exemplary incident storage in the first embodiment. As illustrated in FIG. 5, the incident storage 121 stores “incident ID” and “title” in association with each other. Information that is stored in the incident storage 121 is input in advance by a person in charge in a call center (not illustrated).

In FIG. 5, “incident ID” stores identifiers each of which uniquely identifies an incident, and “title” stores the content of the incidents.

The similarity storage 122 stores a similarity between sets of data of each pair incidents. The information that is stored in the similarity storage 122 is input by a calculator 131 to be described below. The information stored in the similarity storage 122 is the information that is contained in the correct data storage 123 excluding information “positiveness or negativeness” and thus detailed descriptions of the information will be omitted.

The correct data storage 123 stores information on whether each incident pair corresponds to a positive example or a negative example. The information stored in the correct data storage 123 is input by a register 133, which will be described below.

FIG. 6 is a diagram illustrating the exemplary correct data storage in the first embodiment. As illustrated in FIG. 6, the correct data storage 123 stores “first incident”, “second incident”, “similarity” and “positiveness or negativeness” in association with “pair ID”.

In FIG. 6, “pair ID” stores identifiers each of which uniquely identifies an incident pair. “First incident” and “second incident” stores incident IDs of two incidents of which the pair consists. “Similarity” stores similarities of the pairs. “Positiveness or negativeness” stores information on whether the pair corresponds to a positive example or a negative example. A case where the pair corresponds to a positive example can be referred to as “True” and a case where a pair corresponds to a negative example can be referred to as “False” below.

The method storage 124 stores information on similarity calculation methods that are used to perform clustering on incidents. The information that is stored in the method storage 124 is input by a manager (not illustrated in the drawings) of the generation device 10 in advance.

In the first embodiment, the similarity calculation methods covers, for example, cosine similarity, levenshtein distance and word error rate (WER). Detailed descriptions of the method storage 124 will be omitted.

The cluster storage 125 stores information on clusters into which incidents in pairs are classified. The information that is stored in the cluster storage 125 is input by a clustering processor 135 to be described below.

FIG. 7 is a diagram illustrating the exemplary cluster storage in the first embodiment. As illustrated in FIG. 7, the cluster storage 125 stores “pair ID”, “first incident”, “second incident”, and “cluster ID” in association with one another. In FIG. 7, “cluster ID” stores identifiers each of which uniquely identifies a cluster into which a pair of incidents is classified.

The learning model storage 126 stores a learning model that is generated by a model generator 136, which will be described below.

FIG. 4 will be referred back. The controller 130 is a processor that controls the entire generation device 10 and is, for example, a processor. The controller 130 includes the calculator 131, an extractor 132, the register 133, a determination unit 134, the clustering processor 135, and the model generator 136. The calculator 131, the extractor 132, the register 133, the determination unit 134, the clustering processor 135, and the model generator 136 are exemplary electronic circuits of the processor or exemplary processes that are executed by the processor.

The calculator 131 calculates a similarity between incidents in a pair. The calculator 131, for example, vectorizes incidents by any method and calculates a cosine similarity between the vectors to calculate a similarity of the pair of incidents. The calculator 131 stores the calculated similarity between the incidents in a pair in the similarity storage 122.

The calculator 131, for example, calculates a similarity of each of all the pairs of incidents that are stored in the incident storage 121. Alternatively, part of pairs of incidents may be sampled and similarities of the pairs may be calculated. A known technology can be used for the vectorization method, detailed descriptions thereof will be omitted.

The extractor 132 extracts pairs of incidents each of which has a similarity that meets given standards. The extractor 132 outputs information on the incident pairs that are extracted from the similarity storage 122 to the register 133. The extractor 132 extracts an appropriate number of (few tens of) pairs for a person to evaluate by sight.

When, for example, extracting a pair that is highly likely to correspond to a positive example, the extractor 132 extracts a pair whose similarity is equal to or higher than a given threshold. Similarity, when extracting a pair that is highly likely to correspond to a negative example, the extractor 132 extracts a pair whose similarity is lower than a given threshold.

On the other hand, there are pairs of incidents, like Pairs 4100 and 4300 represented in FIG. 2, on which it is difficult to determine whether the pair is a positive example or a negative example from only the similarity. In such a case, the extractor 132, for example, extracts pairs whose similarity is within a given range.

The register 133 registers information on whether a pair of incidents that is extracted is a positive example or a negative example. The register 133 is an exemplary generator.

The register 133 outputs information on titles of extracted pairs of incidents via a communication unit or a display unit (not illustrated in the drawings). The register 133 receives information indicating whether the output pair of incidents corresponds to a positive example or a negative example, which is information that is input by the user (not illustrated in the drawings) of the generation device 10. The register 133 stores the received information on whether the pair is a positive example or a negative example in association with the pair in the correct data storage 123.

The determination unit 134 determines a similarity calculation method that is used for clustering. The determination unit 134 refers to the multiple similarity calculation methods that are stored in the method storage 124 and, using each of the methods, determines whether each of the multiple pairs of incidents that are stored in the correct data storage 123 has to be classified as a positive example or a negative example.

The determination unit 134 determines whether the result of determination using each method and “positiveness or negativeness” stored in the correct data storage 123 match. The determination unit 134 chooses, from the methods, a method enabling the largest number of pairs of incidents for which the the determination result and “positiveness or negativeness” match among the multiple pairs of incidents on which determinations are made.

For example, in a case where determinations are made on 64 pairs, when the determination result and “positiveness or negativeness” match in 50 pairs with the method A, match in 40 pairs with the method B, and match in 45 pairs with the method C, the determination unit 134 chooses the method A. The determination unit 134 outputs the information on the chosen method to the clustering processor 135.

The clustering processor 135 performs clustering on incidents. Using the information on the methods that is output from the determination unit 134, the clustering processor 135 determines a similarity calculation method that is used for clustering. Using the determined method, the clustering processor 135 classifies the incidents that are stored in the incident storage 121 into clusters and stores the result of the classifying in the cluster storage 125.

The model generator 136 generates a learning model. The model generator 136 generates a learning model using the information that is stored in the incident storage 121 and the cluster storage 125 at timing of end of the clustering and stores the learning model in the learning model storage 126. A learning model can be generated by a known method, such as error back propagation (BP), and thus detailed descriptions thereof will be omitted.

Process Flow

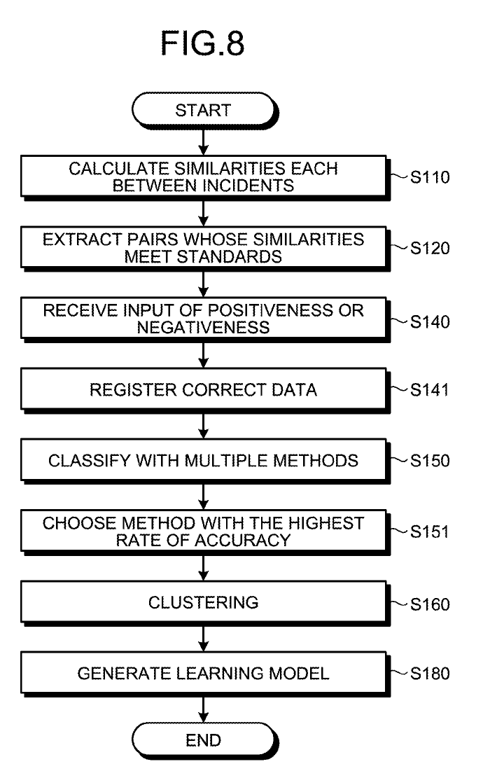

A process of the first embodiment will be described using FIG. 8. FIG. 8 is a flowchart illustrating an exemplary correct data generation process in the first embodiment. In the first embodiment, the generation device 10 starts the correct data generation process according to an instruction that is made by the user (not illustrated in the drawings); however, embodiments are not limited thereto. For example, the generation device 10 may start the correct data generation process at any timing, for example, at a given date and time, when a given period passes from the previous processing or when the number of incidents reaches a given number.

As illustrated in FIG. 8, the calculator 131 of the generation device 10 calculates similarities each between incidents in a pair and stores the similarities in the similarity storage 122 (S110).

The extractor 132 extracts pairs whose similarities meet the standards and outputs the pairs to the register 133 (S120).

The register 133 receives an input of positiveness or negativeness of each of the extracted pairs (S140) and registers correct data in the correct data storage 123 (S141).

Using each of the similarity calculation methods that are stored in the method storage 124, the determination unit 134 classifies the pairs of incidents that are stored in the correct data storage 123 into positive examples and negative examples (S150). The determination unit 134 then chooses the similarity calculation method achieving the highest accuracy of classifying result from the similarity calculation methods and outputs the chosen similarity calculation method to the clustering processor 135 (S151).

Using the similarity calculation method which is output, the clustering processor 135 performs clustering on the incidents that are stored in the incident storage 121 (S160). The clustering processor 135 then receives an evaluation on the result of the clustering (S170) and outputs an instruction to generate a learning model to the model generator 136.

The model generator 136 refers to the incident storage 121 and the cluster storage 125 and generates a learning model (S180) and ends the process.

### Effect

As described above, the generation program in the first embodiment causes a computer to execute a process of, based on multiple sets of data that are stored in a storage, calculating similarities each between sets of data of each data pair contained in the multiple sets of data. The generation program further causes the computer to execute a process of extracting, from the data pairs, a data pair whose calculated similarity meets standards. The generation program causes the computer to execute a process of generating third data that contains information on first data contained in the extracted data pair, information on second data contained in the extracted data pair, and information on whether the first data and the second data are similar to each other. This enables efficient generation of learning data.

The generation program may cause the computer to execute a process of extracting, from the data pairs, a data pair whose similarity is equal to or higher than a first threshold and a data pair whose similarity is lower than a second threshold. This enables preferential extraction of a data pair that is highly likely to be a positive example and a data pair that is highly likely to be a negative example.

The generation program may further cause the computer to execute a process of, using two or more similarity calculation methods, classifying the third data into a positive example or a negative example. The generation program may further cause the computer to execute a process of performing clustering on the multiple sets of data using a similarity calculation method achieving the highest rate of correction in the process of classifying among the two or more similarity calculation methods. The generation program may further cause the computer to execute a process of generating a learning model using a result of the clustering. This makes it possible to specify a similarity calculation method optimum to clustering.

### [b] Second Embodiment

When correct data includes a large number of pairs whose similarities are low and thus are obviously negative examples and pairs whose similarities are distinctly high and thus are obviously positive examples, a similarity calculation method that is inappropriate may be chosen.

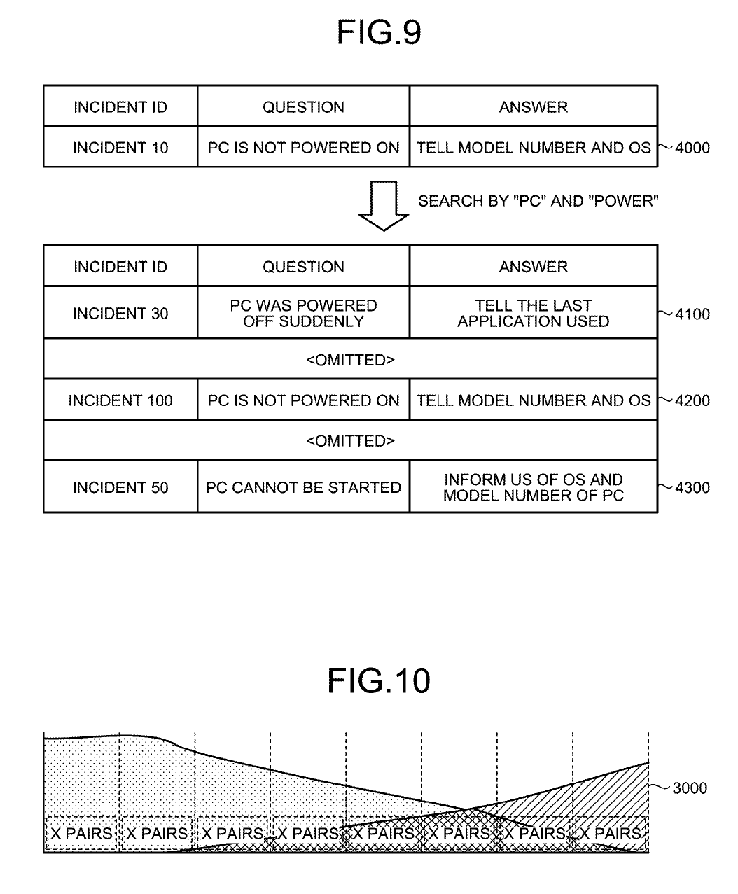

FIG. 9 is a diagram illustrating exemplary similar incidents. Incident 10 that is denoted by a reference number 400 in FIG. 9 contains a question text “PC is not powered on”. As the question text of Incident 10 and the question text of Incident 100 completely match, a high similarity is calculated. In other words, the pair of Incident 10 and Incident 100 corresponds to Pair 4200 represented in FIG. 2; however, it is obvious that a pair of incidents whose question texts completely match corresponds to a positive example and thus inclusion of such pairs in the correct data does not lead to improvement in the system to choose a similarity calculation method.

Furthermore, as in the case of the pair 4100 and the pair 4300 represented in FIG. 2, a similarity of a pair does not necessarily match whether the pair corresponds to a positive example or a negative example. For example, Incident 10 and Incident 30 represented in FIG. 9 have common words “PC” and “power” and thus a high similarity is calculated. The incidents, however, when checked by a person by sight, relate to a problem occurring at a startup and a problem during an operation and the problems occur in different scenes and thus the pair is determined as a negative example. In other words, the pair of Incident 10 and Incident 30 corresponds to Pair 4100 represented in FIG. 2.

Incident 10 and Incident 50 illustrated in FIG. 9 do not contain common words in question texts and thus a low similarity is calculated. When checked by a person by sight, however, both the incidents relate to problems occurring at startups and thus the pair is determined as a positive example. In other words, the pair of Incident 10 and Incident 50 corresponds to Pair 4300 illustrated in FIG. 2.

In the second embodiment, a configuration to extract pairs of incidents without causing disproportion in similarities will be described. FIG. 10 is a diagram illustrating an exemplary pair extraction process in the second embodiment. FIG. 10 is an exemplary graph obtained by enlarging Area 3000 represented in FIG. 2.

FIG. 10 illustrates an example where a distribution of pairs of incidents are divided into eight segments according to the similarities. In the second embodiment, a generation device 20, which will be described below, samples “X pairs” equally from each of the divided eight segments. This enables extraction of pairs of incidents without causing disproportion in similarities.

Furthermore, as described above, when incidents amounts to few tens of thousands incidents, combinations of pairs of incidents amount to more than a hundred million combinations and thus it is not efficient to calculate similarities of all the pairs.

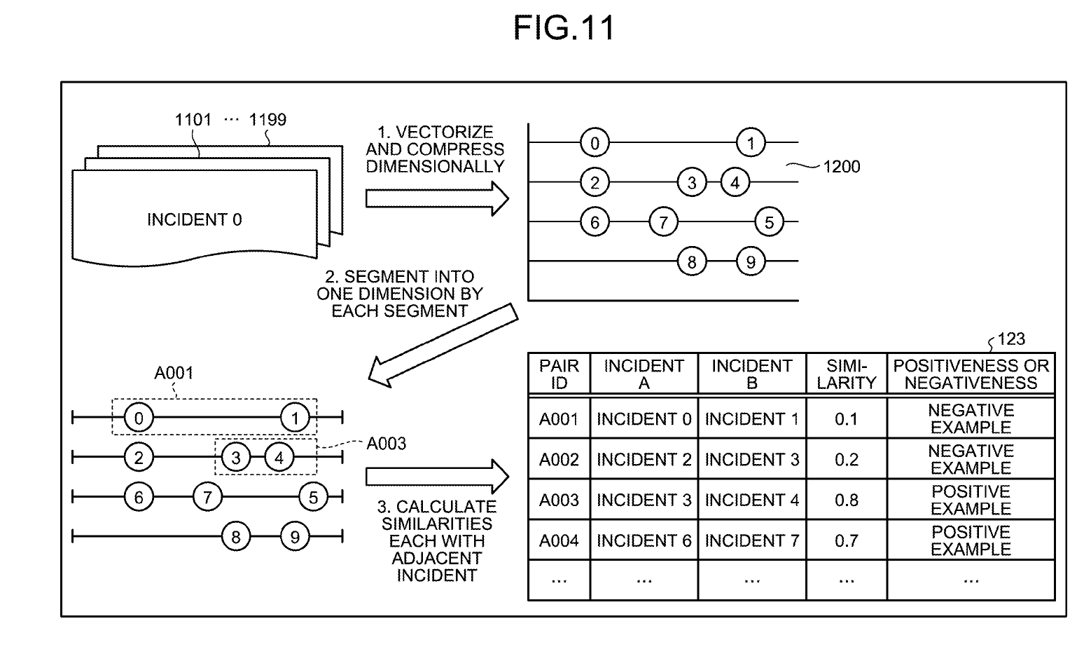

Thus, in the second embodiment, a configuration to narrow down pairs of incidents whose similarities are to be calculated will be described. FIG. 11 is a diagram illustrating an exemplary similarity calculation process in the second embodiment. As illustrated in FIG. 11, in the similarity calculation process in the second embodiment, the generation device 20 vectorizes Incident 0 and multiple Incidents 1101 to 1199 and performs dimensional compression on the vectors using a known method. The generation device 20 then segments each dimensionally-compressed incident 1200 into z one-dimensional segments. The generation device 20, for example, further calculates a similarity of a pair of incidents adjacent to each other like Pairs A001 and A003.

Accordingly, it is possible to narrow the number of pairs of n incidents whose similarities are to be calculated down to (n−z) from (n̂2/2). As illustrated in FIG. 11, for example, when there are a large number of incidents, even a pair of incidents that are adjacent to each other, that is, a pair of incidents whose similarity is high, has often a low similarity as Pair A001 has and thus there is a high possibility that a sufficient number of not only positive examples but also negative examples are secured.

In order to increase accuracy when the accuracy of clustering is low, it is preferable that correct data be further added and a similarity calculation method be chosen again. The generation device 20 according to the second embodiment reuses the evaluation on the result of the clustering as correct data.

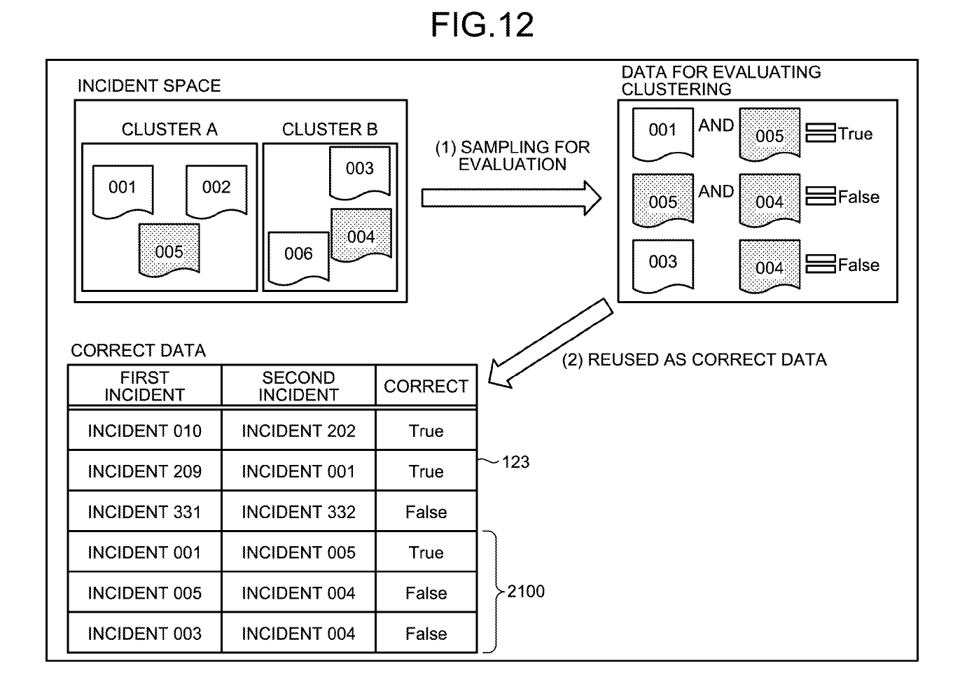

FIG. 12 is a diagram illustrating an exemplary clustering evaluation process in the second embodiment. FIG. 12 illustrates an example where, in clustering, Incidents “001”, “002” and “005” are classified into Cluster A, Incidents “003”, “004” and “006” are classified into Cluster B.

In this case, the generation device 20, for example, chooses a representative incident from each of the cluster sand samples a pair of the representative incident and another cluster that is classified into the same cluster as that of the representative incident and a pair of the representative incident and a representative cluster that is classified into a different cluster as pairs to be evaluated. FIG. 12 illustrates an example where Incidents “004” and “005” are chosen as representative incidents. The generation device 20 then receives an input of evaluation on whether each of the pairs to be evaluated corresponds to a positive example or a negative example, which is an input made by the user (not illustrated in the drawings), or the like.

In the example illustrated in FIG. 12, Pair of Incidents “001” and “005” that belong to the same cluster are evaluated as “True (positive example)”. On the other hand, the pair of Incidents “003” and “004” that belong to the same cluster and the pair of Incidents “005” and “004” that belong to the different clusters are evaluated as “False (negative example)”.

The generation device 20 adds the input evaluations and the pairs of incidents in association with each other as correct data to the correct data storage 123. Accordingly, it is possible to reuse the result of evaluation on the clustering as correct data.

Functional Block

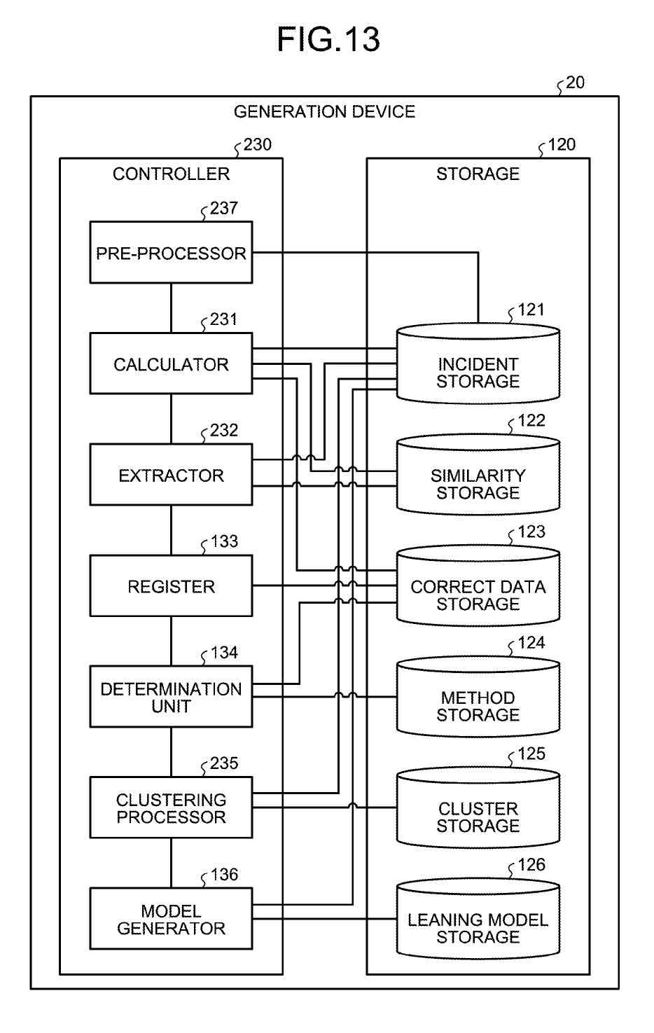

A generation device that executes the generation program will be described using FIG. 13. FIG. 13 is a diagram illustrating an exemplary generation device in the second embodiment. In the following second embodiment, the same components as those illustrated in the previously-described drawings are denoted with the same reference numbers as those in the previously-described drawings and redundant descriptions thereof will be omitted.

As illustrated in FIG. 13, the generation device 20 in the second embodiment includes the storage 120 and a controller 230. The controller 230 is a processor that controls the entire generation device 20 and is, for example, a processor. The controller 230 includes a calculator 231, an extractor 232, the register 133, the determination unit 134, a clustering processor 235, the model generator 136 and a pre-processor 237. The calculator 231, the extractor 232, the clustering processor 235 and the pre-processor 237 are exemplary electronic circuits of the processor and exemplary processes that are executed by the processor.

The pre-processor 237 specifies pairs of incidents adjacent to each other. The pre-processor 237 vectorizes the incidents that are stored in the incident storage 121 and performs two-dimensional compression on the incidents. A known technology can be used for the dimensional compression method and thus detailed descriptions thereof will be omitted.

The pre-processor 237 specifies incidents that are adjacent to each other and are contained in each segment resulting from segmentation. For example, in the example illustrated in FIG. 11, the pre-processor 237 specifies a pair of “Incident 7” and “Incident 5” and a pair of “Incident 8” and “Incident 9” in addition to the pairs exemplified in the correct data storage 123. The pre-processor 237 outputs the specified pairs to the calculator 231.

The calculator 231 calculates a similarity between adjacent incidents in a pair. The calculator 231 calculates similarities of the pairs of incidents that are output from the pre-processor 237 and stores the similarities in the similarity storage 122.

The extractor 232 extracts a pair of incidents whose similarity meets given standards. The extractor 232 extracts pairs each of which meets a given condition by using, for example, the same method as that of the extractor 132 in the first embodiment.

The extractor 232, for example, segments the incident pairs that are stored in the similarity storage 122 into a given number of segments according to the similarities as exemplified in FIG. 10. The extractor 232 equally extracts pairs from each of the segments, for example, 10 pairs from one segment.

The extractor 232 may extract a different number of pairs from each segment or extract pairs not from all the segments but from specific segments. For example, the extractor 232 may extract pairs from six of the segments exemplified in FIG. 10, excluding the segment with the lowest similarity and the segment with the highest similarity. The extractor 232 may extract the largest number of pairs, for example, from the intermediate segment.

The clustering processor 235 performs clustering on incidents, samples incidents whose corresponding results of clustering are to be evaluated, and receives evaluations on pairs containing the incidents. The clustering processor 235 then stores the pairs of incidents contained in the received evaluations and the results of evaluation in the correct data storage 123 as correct data.

For example, as illustrated in FIG. 12, the clustering processor 235 chooses Incidents “001” and “005” as representative incidents and outputs the incidents to the user (not illustrated in the drawings). The clustering processor 235 receives an evaluation of “True (positive example)” on the pair of Incidents “001” and “005” that belong to the same cluster. In the example illustrated in FIG. 12, the clustering processor 235 receives an evaluation “False (negative example)” on the pair of Incidents “003” and “004” that belong to the same cluster. Similarly, the clustering processor 235 receives an evaluation “False (negative example)” on the pair of Incidents “005” and “004” that belong to the different clusters.

Process Flow

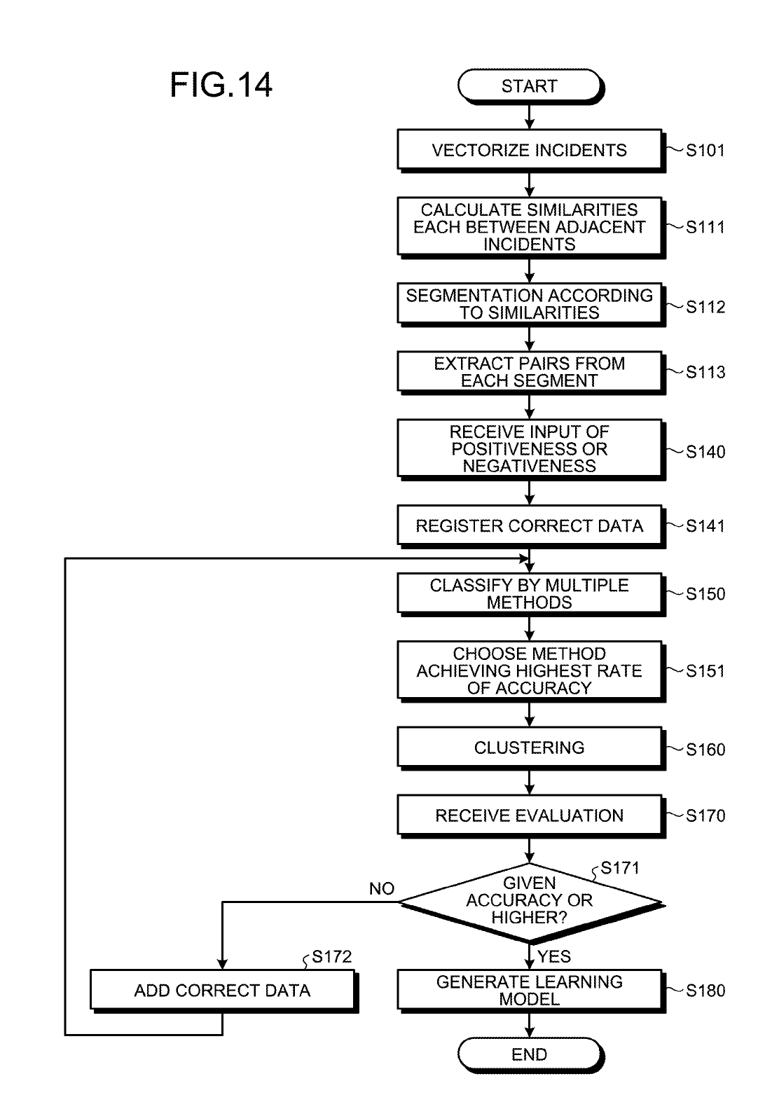

A process in the second embodiment will be described using FIG. 14. FIG. 14 is a flowchart illustrating an exemplary correct data generation process in the second embodiment. In the following descriptions, the steps denoted with the same reference numbers as those of the steps in FIG. 8 are the same steps as those in FIG. 8 and thus detailed descriptions thereof will be omitted.

As illustrated in FIG. 14, the pre-processor 237 of the generation device 20 victorizes and sorts incidents and outputs the vectorized and sorted incidents to the calculator 231 (S101).

The calculator 231 then calculates similarities each between adjacent incidents in a pair and stores the similarities in the similarity storage 122 (S111).

The extractor 232 sorts each of the pairs according to the similarities stored in the similarity storage 122 and performs segmentation according to each range of similarity (S112). The extractor 232 extracts a given number of pairs from each area obtained by segmentation and outputs the pairs to the register 133 (S113).

The clustering processor 135 receives an evaluation on the result of the clustering at S160 (S170). The clustering processor 135 determines whether accuracy of clustering that is calculated based on the evaluation on the process result is equal to or higher than a given accuracy (S171). When it is determined that the accuracy is lower than the given accuracy (NO at S171), the clustering processor 135 adds the evaluation on the result of the clustering to the correct data storage 123 as correct data (S172) and returns to S150 to repeat the process.

When it is determined that the accuracy is equal to or higher than the given accuracy (YES at S171), the clustering processor 135 outputs an instruction to generate a learning model to the model generator 136. The model generator 136 generates a learning model (S180) and ends the process.

### Effect

As described above, the generation program in the second embodiment causes a computer to execute a process of classifying multiple data pairs into multiple segments according to similarities. The generation program further causes the computer to execute a process of extracting multiple data pairs such that the number of sets of data contained in an intermediate segment of the multiple segments, excluding the top segment and the bottom segment, meets a given condition. This enables exclusion of data pairs that are obviously positive examples and pairs that are obviously negative examples.

The generation program may further cause the computer to execute a process of vectorizing and sorting multiple sets of data. The generation program may further cause the computer to execute a process of specifying data pairs whose sets of data are adjacent to each other as a result of the sorting, calculating similarities each between the sets of data of the data pairs, and sampling and extracting data pairs whose similarities are within a given range. Accordingly, it is possible to narrow down pairs of incidents whose similarities are to be calculated.

The generation program further causes the computer to execute a process of adding, to the third data, a result of evaluation that is input for the result of the clustering. This enables the correct data to reflect the result of evaluation on the clustering.

### [c] Third Embodiment

The embodiments of the invention has been described. The present invention may be carried out in various different modes in addition to the above-described embodiments. Thus, different embodiments will be described below.

Neural Network

For example, to generate a learning model, any neural network, such as a recurrent neural network (RNN) or a convolutional neural network (CNN) may be used. Furthermore, for a learning method, known various methods, such as backpropagation, may be used. A neural network has a multi-layered structure consisting of, for example, an input layer, an intermediate layer (hidden layer) and an output layer and each of the layers has a structure in which multiple nodes are connected with edges. Each layer has a function referred to as “activation function”, edges have “weights” and the value of each node is calculated from the value of the node of the previous layer, the value of a connection edge, and an activation function of the layer. For the calculation method, various known methods may be employed.

Embodiments are not limited to distributed learning on incidents in Japanese. For example, incidents in another languages, such as English or Chinese, may be used.

System

Among the processes described in each of the embodiments, part of the processes that have been described as being performed automatically may be performed manually. Alternatively, part of the processes that have been described as being performed manually may be performed automatically by a known method. In addition, the process procedure, control procedure, specific names, and information containing various types of data and parameters that are represented in the descriptions given above and the accompanying drawings may be changed optionally unless otherwise noted.

Each component of each device illustrated in the drawings is a functional idea and thus need not necessarily be configured physically as illustrated in the drawings. In other words, specific modes of distribution or integration in each device are not limited to those illustrated in the drawings. In other words, all or part of the components may be distributed or integrated functionally or physically according to a given unit in accordance with various types of load and usage. For example, the calculator 131 and the extractor 132 represented in FIG. 4 may be integrated. Furthermore, the clustering processor 235 represented in FIG. 13 may be distributed to a processor that performs clustering and a processor that receives an evaluation on a processing result. Furthermore, all or any part of the processing functions that are implemented in the respective devices may be implemented by a CPU and a program that is analyzed and executed by the CPU or may be implemented as hardware using a wired logic.

Hardware Configuration

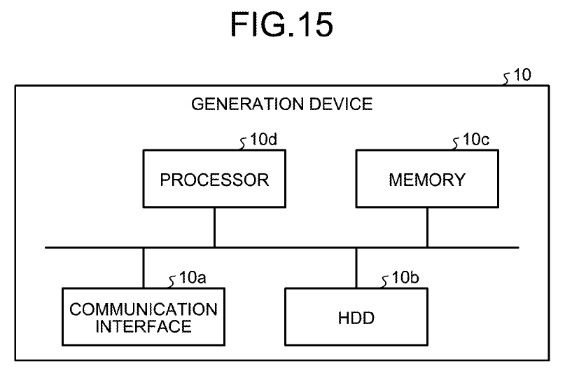

FIG. 15 is a diagram illustrating an exemplary hardware configuration. As illustrated in FIG. 15, the generation device 10 includes a communication interface 10a, a hard disk drive (HDD) 10b, a memory 10c and a processor 10d. The generation device 10 in the first embodiment will be described below, and generation devices in other embodiments can be realized with the same configuration.

The communication interface 10a is a network interface card that controls communication with other devices, or the like. The HDD 10b is an exemplary storage device that stores programs and data.

Examples of the memory 10c include a random access memory (RAM), such as a synchronous dynamic random access memory (SDRAM), a read only memory (ROM), or a flash memory. Examples of the processor 10d include a central processing unit (CPU), a digital signal processor (DSP), a field programmable gate array (FPGA), and a programmable logic device (PLD).

The generation device 10 operates as an information processing device that reads and executes the program to execute the learning method. In other words, the generation device 10 executes a program to implement the same functions as those of the calculator 131, the extractor 132, the register 133, the determination unit 134, the clustering processor 135 and the model generator 136. As a result, the generation device 10 is able to execute processes to implement the same functions as those of the calculator 131, the extractor 132, the register 133, the determination unit 134, the clustering processor 135 and the model generator 136. Programs according to other embodiments are not limited to those executed by the generation device 10. For example, the present invention is applicable to a case where another computer or another server executes the program or a case where another computer and another server cooperate to execute the program.

According to an embodiment, efficient generation of learning data is enabled.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a generation program that causes a computer to execute a process comprising:
calculating similarities respectively, between first data and second data included in each pair of data stored in a storage;
extracting, from a plurality of pairs of data stored in the storage, a pair whose calculated similarity meets standards; and
generating third data that contains information on the first data contained in the extracted pair, information on the second data contained in the extracted pair, and information on whether the first data and the second data that are contained in the extracted pair are similar to each other.

2. The non-transitory computer-readable recording medium according to claim 1, wherein the extracting includes extracting, from the data pairs, a data pair whose similarity is equal to or higher than a first threshold and a data pair whose similarity is lower than a second threshold.

3. The non-transitory computer-readable recording medium according to claim 1, wherein the extracting includes classifying the plurality of data pairs into a plurality of segments according to the similarities and extracting the plurality of data pairs such that the number of sets of data contained in an intermediate segment of the plurality of segments, excluding a top segment and a bottom segment, meets a given condition.

4. The non-transitory computer-readable recording medium according to claim 1, wherein
the process further includes vectorizing and sorting the plurality of sets of data, and
the calculating includes specifying data pairs whose sets of data are adjacent to each other as a result of the sorting and calculating similarities between the sets of data of the data pairs, and
the extracting includes sampling and extracting data pairs whose similarities are within a given range from the data pairs.

5. The non-transitory computer-readable recording medium according to claim 1, wherein
the process further includes:
using two or more similarity calculation methods, classifying the third data into a positive example for which it is determined that the first data and the second data are similar to each other or a negative example for which it is determined that the first data and the second data are not similar to each other;
performing clustering on the plurality of sets of data using a similarity calculation method achieving the highest rate of correction in the classifying from the two or more similarity calculation methods; and
generating a learning model using a result of the clustering.

6. The non-transitory computer-readable recording medium according to claim 5, wherein the process further includes adding, to the third data, a result of evaluation that is input for the result of the clustering.

7. A generation method comprising:
calculating similarities respectively, between first data and second data included in each pair of data stored in a storage;
extracting, from a plurality of pairs of data stored in the storage, a pair whose calculated similarity meets standards; and
generating third data that contains information on the first data contained in the extracted pair, information on the second data contained in the extracted pair, and information on whether the first data and the second data that are contained in the extracted pair are similar to each other, by a processor.

8. A generation device comprising:
a storage that stores a plurality of sets of data; and
a processor coupled to the storage, the processor configured to:
calculate similarities respectively, between first data and second data included in each pair of data stored in the storage;
extract, from a plurality of pairs of data stored in the storage, a pair whose calculated similarity meets standards; and
generate third data that contains information on the first data contained in the extracted pair, information on the second data contained in the extracted pair, and information on whether the first data and the second data that are contained in the extracted pair are similar to each other.
